(19) United States
(12) Patent Application Publication
(10) Pub. No.: US 2006/0075164 A1
(43) Pub. Date: Apr. 6, 2006

(54) Method and apparatus for using advanced host controller interface to transfer data

(76) Inventor: Eng Hun Ooi, Georgetown (MY)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 10/948,803

(22) Filed: Sep. 22, 2004

(51) Int. Cl. G06F 3/06

(52) U.S. Cl. 710/58; 710/59

(57) ABSTRACT

A method and apparatus for entering a mode of a host controller and omitting a state of a state machine sequence of the host controller for data exchange by the host controller are disclosed. For one embodiment, the method and apparatus include setting a bit before a command information is transmitted to a separate device and exchanging data without sending the command information to the separate device. The bit of the embodiment indicates a current task file status.

### FIELD

Embodiments of the invention relate to the field of transferring data in a computer system; and more specifically, to exchanging data with an Advanced Host Controller Interface (AHCI).

### BACKGROUND

Serial Advanced Technology Attachment (SATA) devices such as CD ROMs, Hard Disk Drives, DVD RAMs, etc., can be developed in a focused manner for computer systems that have Host Controllers (HC), compliant with the Serial ATA Host Controller Interface (AHCI) Specification, Revision 1.0, released Apr. 13, 2004. The AHCI Specification describes a device that implements the specification and acts as an interface between a SATA device and memory in a computer system. The interface device is known, for example, as a Host Controller, a Host Bust Adapter, etc. Because the device is described by a specification, it is expected to respond to pre-established commands and procedures.

For example, a HC typically precedes data exchange by sending a command to a SATA device. The HC then waits for a response before data exchange can occur. But, testing a HC's ability to exchange data becomes difficult because typically when testing a HC, there is typically no SATA device present. As a result, it is unnecessary for the HC to send a command and wait for a response from a device that is not present.

### BRIEF DESCRIPTION OF THE DRAWINGS

Embodiments of the invention may be best understood by referring to the following description and accompanying drawings that illustrate such embodiments.

In the drawings:

FIG. 1-A illustrates an exemplary configuration of a Host Controller coupled to a device, according to one embodiment.

FIG. 1-B illustrates an exemplary configuration of Host Controller coupled to a second Host Controller, according to one embodiment.

FIG. 2 is a flowchart of one embodiment of a process for exchanging data using a Host Controller.

FIG. 3 is a flowchart of an alternative embodiment of a process of exchanging data using a Host Controller.

FIG. 4 illustrates an exemplary system comprising a processor and Host Controller(s) to exchange data, according to embodiments of the present invention.

### DETAILED DESCRIPTION

In the following description, for purposes of explanation, numerous specific details are set forth in order to provide a thorough understanding of the present invention. It will be evident, however, to one skilled in the art that embodiments of the present invention may be practiced without these specific details.

Embodiments of the present invention allow for omitting states of a state machine sequence for data exchange, wherein a HC enters a mode of operation. In one embodiment, the HC receives a request to exchange data where the request to exchange data can be either a request to transmit data or a request to receive data. Accordingly, a bit is cleared upon entering the mode and set in a subsequent state of the state machine prior to transmitting a command that is to be received by a device. Setting the bit prior to sending a command that is to be received by a device is to allow the HC to omit states ordinarily performed prior to data transmission or reception. According to one embodiment, the HC is an Advanced Host Controller Interface HC.

Therefore, as will be described in more detail below, embodiments of the present invention allow for the improved ability to test a Host Controller by reducing operations to be performed in a data exchange of a HC.

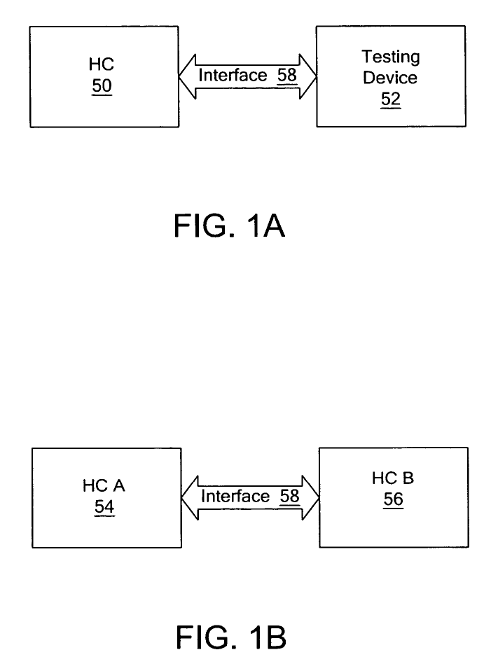

FIG. 1-A illustrates a Host Controller (HC) 50 coupled to a Host Controller testing device (Testing Device) 52. The HC 50 is coupled to the testing device 52 by a SATA interface 58. The interface can be any suitable interface that provides the HC 50 the ability to communicate with the Testing Device 52. Furthermore, the testing device 52 can be any suitable device capable of providing the functionality needed to test a HC.

FIG. 1-B illustrates an alternative testing configuration where a first Host Controller (HC-A) 54 is coupled to a second Host Controller (HC-B) 56. The HCs can be coupled by any suitable interface, as described above. By coupling two HCs together, a computer system can be used to test the Host Controllers data reception and transmission.

Embodiments of the present invention can be implemented by Host Controllers in the configurations illustrated in FIG. 1-A and FIG. 1-B. The configurations of FIGS. 1-A and 1-B are provided by way of example and not by way of limitation, as there can be other suitable configurations of Host Controllers.

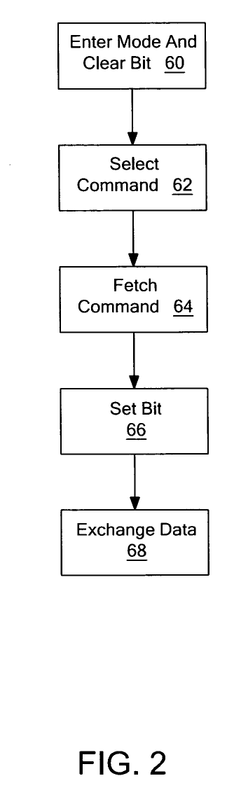

FIG. 2 illustrates a flow diagram describing the process of exchanging data with a HC, in accordance with one embodiment. In process block 60, the HC enters a mode. For one embodiment of the invention, the mode can be a mode to test the HC. Furthermore, in one embodiment, the mode can be specifically to test data transmission or data reception by the HC in the mode. The HC can enter the mode as directed from software instructions stored in computer system memory 26. The HC can also enter the mode through instructions received by the HC from an external device coupled to the HC, such as that illustrated in FIG. 1-A or FIG. 1-B. Embodiments for entering a mode of the HC are not limited by the processes described above. Furthermore, embodiments can use the HC device driver to set the mode and/or modifications to the HC.

For one embodiment, upon entering the mode (process block 60) the HC clears a bit to indicate that the HC is not busy. More specifically, the bit is cleared to signify that the HC is not currently performing an operation. One embodiment, for example, clears the PxTFD.STS.BSY bit (BSY bit) upon entering the mode. For the one embodiment, the BSY bit is a specific register bit that indicates the current status of task file data associated with the HC's ability to exchange data with a SATA device.

Next, the HC selects a command (process block 62) that the HC will issue to a device to exchange data. The HC then fetches the command header for the selected command (process block 64). For one embodiment, the selecting of a command can be triggered by computer system, such as system 10, or by an external hardware device as illustrated in FIGS. 1-A and 1-B, etc.

Typically the HC would remain idle after fetching the command header (process block 64) until the command is ready to issue to the device. However, for one embodiment, after fetching the command header, a bit is set to indicate that the HC is busy, i.e. performing an operation (process block 66). For one embodiment, the BSY bit is set to indicate the system is busy. By setting the bit to indicate that the system is busy, the HC advances to exchanging data (process block 68). Data exchange can be either data transmission or data reception.

When the bit is set to indicate the HC is busy (process block 66), the HC does not send a command to a SATA device. Nor does the HC need to receive an acknowledgment that the command was successfully sent. Furthermore, by setting the bit, the HC will also not have to wait for a SATA device to be ready to accept data or wait for acknowledgement that the SATA device is ready to receive data. Instead, the HC proceeds to data exchange.

Since the HC proceeds directly to data exchange when the bit is set, the HC omits states in a state machine sequence for data transmission and/or data reception. For one embodiment, when transmitting data in the mode, the HC omits at least one or more of the following states of the state machine sequence: Command Frame Information Structure Transmit (CFIS:Xmit), Command Frame Information Structure Success (CFIS:Success), Host Idle (H:Idle), Non-Data Frame Information Structure Receive Entry (NDR:Entry), and Non-Data Frame Information Structure Receive Accept (NDR:Accept). In an alternative embodiment, other states and processes could be omitted. Thus, according to one embodiment, the state machine sequence for data transmission when the HC is in the mode would be: H:Idle, H:SelectCmd, H:FetchCmd, H:Idle, DX:Entry, and DX:Transmit. According to one embodiment, the bit is set upon entering the second H:Idle state in the state machine sequence for data transmission, where H:Idle refers to a state where the Host Controller is inactive.

Similarly, when receiving data in the mode, the HC omits at least one or more of the following states, according to one embodiment: CFIS:Xmit, CFIS:Success, and H:Idle. Thus, the state machine sequence for data reception would be: H:Idle, H:SelectCmd, H:FetchCmd, H:Idle, DR:Entry, and DR:Receive. In an alternative embodiment, other states and processes could be omitted. According to one embodiment, a bit is set upon entering the second H:Idle state in the state machine sequence for data reception.

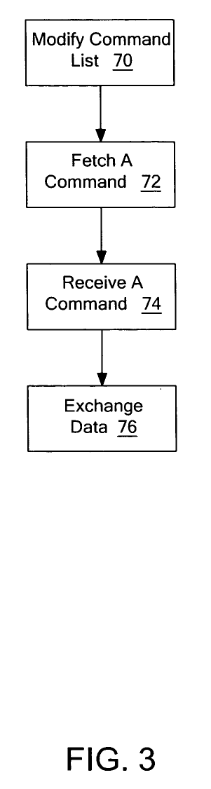

FIG. 3 illustrates a flow diagram describing the process of exchanging data with a HC, in accordance with an alternative embodiment embodiment. According to the embodiment, a HC device driver and an enhanced HC can exchange data by omitting states and processes for data exchange, as discussed above. As illustrated in FIG. 3, the AHCI device driver would modify the content of a command list that would be received by a HC (process block 70). Included in a command list is a Command Frame Information Structure (CFIS) with a corresponding Command Frame Information Structure Length (CFL). The AHCI device driver would set the CFL to zero. By setting the CFL=0, the enhanced Host Controller would not process the CFIS. As a result, the Host Controller would be able to exchange data without sending a command to a device coupled to the HC and without waiting for the device to acknowledge the command was received.

After the CFL is set to zero, the HC can select a command to exchange data (process block 72) and fetch the command header (process block 74), just as the HC did with respect to the embodiment illustrated in FIG. 2. However, unlike the embodiment illustrated in FIG. 2, the embodiment of FIG. 3 need not set a bit after the HC fetches the command header. If the CFL=0, the HC does not transmit a command to a device nor does the HC await an acknowledgement that the command was received by the device. Instead, after the command header is fetched, the HC will advance to data exchange when CFL=0 (process block 76).

Such an embodiment would allow for the improved ability to test a HC. According to the embodiment illustrated in FIG. 3, the method allows the flexibility to send and/or receive a command with a test HC. Furthermore, such an embodiment would provide a flexible method to test a HC where software and/or hardware will execute a variety of commands. According to one embodiment, optionally setting CFL=0 would allow for a mixture of commands where only some commands require CFIS to be sent to a testing device.

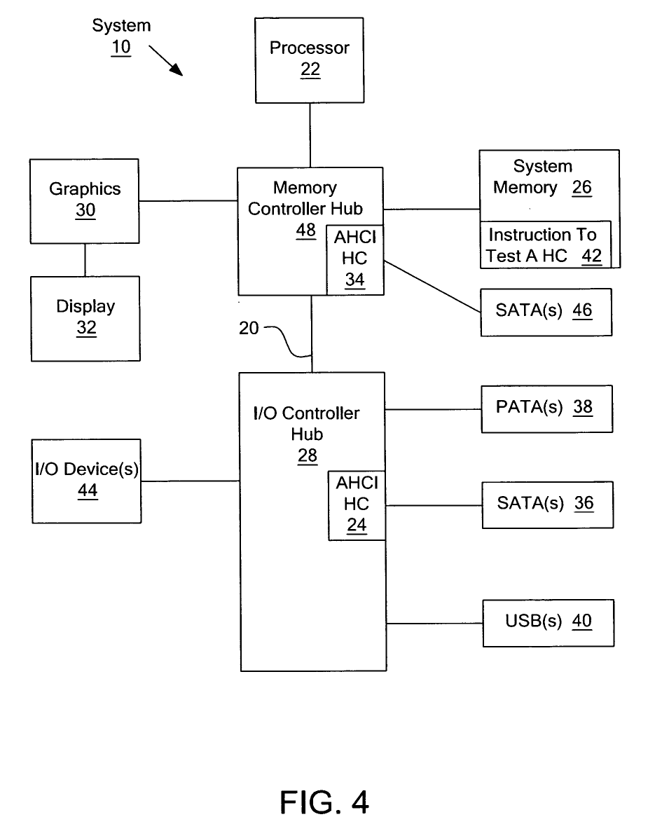

FIG. 4 illustrates a system 10 to implement the apparatuses and methods described herein, according to one embodiment. Although described in the context of system 10, embodiments may be implemented in any suitable computer system.

As illustrated in FIG. 4, computer system 10 comprises at least one HC 24. Computer system 10 also includes memory 26, and an input/output controller hub (ICH) 28. Processor 22, memory 26, HC(s) 24, and ICH 28 are coupled to a memory controller hub 48. The ICH 28 is coupled to the memory controller hub via a hub link 20. Alternatively, HC(s) 34 can additionally be coupled to or integrated into memory controller hub 48.

System memory 26 is to store data and/or instructions for computer system 10, and may comprise any suitable memory, such as dynamic random access memory (DRAM), synchronous dynamic random access memory (SDRAM), or extended data output random access memory (EDO RAM) for example. The computer system 10 further includes Graphics controller 30 coupled to a display 32, such as a cathode ray tube (CRT) or liquid crystal display (LCD), for example.

ICH 28 provides an interface to I/O devices or peripheral components for computer system 10. ICH 28 may comprise any suitable interface controller(s) to provide for any suitable communication link to processor 22 and memory 26. ICH 28 also provides an interface to I/O device(s) 44 such as, for example, a mouse, a keyboard, a floppy disk drive, and/or any other suitable I/O device. The ICH 28 may also provide alternative interfaces for devices such as Parallel Advanced Technology Attachment (PATA) devices 38 and/or Universal Serial Bus (USB) devices 40.

The HC(s) 24 and 34 provide an interface for any suitable SATA device(s) 36 and/or 46 to processor 22 and memory 26, such as a hard disk drive (HDD), compact disc read only memory (CD ROM), digital video disk read only memory (DVD ROM) for example, to store and/or retrieve data and/or instructions.

System memory 26 further includes instructions 42 to test a HC, according to one embodiment, by omitting processes and states as discussed herein. For an alternative embodiment, the instructions need not reside in memory 26, as the instructions can be included in firmware within computer system 10, a dedicated circuit within computer system 10, etc.

Accordingly, computer system 10 includes a machine-readable medium on which is stored a set of instructions (i.e., software) embodying any one, or all, of the methodologies described herein. For example, software can reside, completely or at least partially, within memory 26 and/or within processor 22. For the purposes of this specification, the term “machine-readable medium” shall be taken to include any mechanism that provides (i.e., stores, retrieves, and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
entering a mode of a Host Controller; and
omitting a state of a state machine sequence of the Host Controller prior to data exchange by the Host Controller.

2. The method of claim 1 further comprising:
clearing a bit to indicate the Host Controller is not busy upon entering the mode;
setting the bit to indicate the Host Controller is busy upon entering a subsequent state in the state machine sequence prior to the data exchange; and
exchanging data.

3. The method of claim 2 wherein the bit indicates a current task file status.

4. The method of claim 2 wherein the bit is set before a command information is transmitted that is to be received by a separate device.

5. The method of claim 1, wherein omitting the state for data exchange includes omitting at least one of:
transmitting a command that is to be received by a device; and
receiving an acknowledgement that the command was transmitted successfully.

6. The method of claim 5 further includes omitting at least one of:
waiting for the device to determine if the device is ready to accept data; and
receiving a verified response that the device is ready to accept data.

7. The method of claim 1, wherein the data exchange is one of a data transmission or a data reception.

8. The method of claim 1, wherein the Host Controller is an Advanced Host Controller Interface Host Controller.

9. The method of claim 1, wherein the mode is a test mode.

10. A method comprising:
a Host Controller fetching a command;
the Host Controller receiving the command; and
the Host Controller exchanging data without transmitting a command information that is to be received by a separate device.

11. The method of claim 10 wherein the Host Controller receiving a command further includes the Host Controller receiving a command with a modified command structure.

12. The method of claim 11 wherein the modified command structure is a command with Command Frame Information Structure length equal to zero.

13. A method comprising:
a Host Controller fetching a command;
the Host Controller receiving the command with a modified command structure; and
the Host Controller exchanging data without transmitting a command that is to be received by a separate device.

14. The method of claim 13 further includes the Host Controller exchanging data without waiting for the separate device to acknowledge the command was received.

15. The method of claim 14 wherein the modified command structure includes a Command Frame Information Structure Length equal to zero.

16. An apparatus comprising:
means for entering a mode of a Host Controller; and
means for omitting a state of a state machine sequence of the Host Controller prior to data exchange by the Host Controller.

17. The apparatus of claim 16 further comprising:
means for clearing a bit to indicate the Host Controller is not busy upon entering the mode;
means for setting the bit to indicate the Host Controller is busy upon entering a subsequent state in the state machine sequence prior to the data exchange; and
means for exchanging data.

18. The apparatus of claim 16, wherein means for omitting the state for data exchange includes a means for omitting at least one of:
means for transmitting a command that is to be received by a separate device; and
means for receiving an acknowledgement that the command was transmitted successfully.

19. The apparatus of claim 18 further includes omitting at least one of:
means for waiting for the separate device to determine if the separate device is ready to accept data; and
means for having a verified response that the separate device is ready to accept data.

20. An apparatus comprising:
means for fetching a command;
means for receiving the command; and
means for exchanging data without transmitting a command information that is to be received by a separate device.

21. The method of claim 20 wherein the Host Controller receiving a command further includes the Host Controller receiving a command with a modified command structure.

22. The method of claim 21 wherein the modified command structure is a command with Command Frame Information Structure length equal to zero.

23. An apparatus comprising:
means for fetching a command;
means for receiving a command;
means for exchanging data without transmitting a command information that is to be received by a separate device; and
means for exchanging data without waiting for the separate device to acknowledge the command information was received.

24. The apparatus of claim 23 further comprises means for receiving the command information with a modified command structure.

25. The apparatus of claim 24 wherein the command information with a modified command structure is a command with a Command Frame Information Structure Length equal to zero.

26. An apparatus comprising:
a host controller, the host controller to:
fetch a command from a memory;
receive the command from the memory; and
exchange data with the host controller between the memory and a separate device without transmitting a command information that is to be received by the device.

27. The apparatus of claim 26 wherein the Host Controller is a Serial Advanced Technology Attachment Advanced Host Controller Interface Host Controller.

28. The apparatus of claim 26 wherein the device is a Serial Advanced Technology Attachment device.

29. A system comprising:
a system bus;
a Synchronous Dynamic Random Access Memory; and
a Host Controller coupled to the bus, the Host Controller to:
fetch a command from system memory;
receive the command from system memory; and
exchange data with the host controller between a separate device and system memory without transmitting a command information that is to be received by the separate device.

30. The system of claim 29 wherein exchange data is one of a transmit data or a receive data.

31. The system of claim 29 wherein the Host Controller is a Serial Advanced Technology Attachment Advanced Host Controller Interface Host Controller.

32. An article of manufacture comprising:
a machine-accessible medium including data that, when accessed by a machine, cause the machine to perform operations comprising,
a Host Controller fetching a command from a memory;
the Host Controller receiving the command from the memory; and
the Host Controller exchanging data between a separate device and the memory without transmitting a command information that is to be received by the separate device.

33. The article of manufacture of claim 32 wherein the machine-accessible medium further includes data that cause the machine to perform operations comprising the Host Controller exchanging data without receiving an acknowledgement that the command was transmitted successfully.

34. The article of manufacture of claim 33 wherein the Host Controller is a Serial Advanced Technology Attachment Advanced Host Controller Interface Host Controller.
